(19) United States
(12) Patent Application Publication
(10) Pub. No.: US 2007/0101634 A1
(43) Pub. Date: May 10, 2007

(54) Fishing lure assembly

(76) Inventor: Thomas W. Clapp, Wayzata, MN (US)

Correspondence Address: CLARK HILL, P.C., 500 WOODWARD AVENUE, SUITE 3500, DETROIT, MI, 48226, US

(21) Appl. No.: 11/269,415

(22) Filed: Nov. 7, 2005

(51) Int. Cl. A01K 83/02; A01K 85/02

(52) U.S. Cl. 43/35; 43/42.41

(57) ABSTRACT

The fishing lure assembly is a completely weedless lure because hooks in the fishing lure assembly are completely retracted into a housing. This prevents the fishing lure assembly from snagging weeds or getting caught in debris in the water once the fishing lure assembly is cast therein. The fishing lure assembly includes a fulcrum about which the hooks are spring loaded. A trigger is rotatably secured within the housing. The trigger receives and hold the hooks in their respective retracted positions and, upon a fish moving the trigger, the hooks will be released to catch the fish.

### BACKGROUND ART

1. Field of the Invention

This invention generally relates to fishing lures. More specifically, the invention relates to fishing lure assemblies that have the ability to protect the fishing lure from snagging objects in the water prior to the fishing lure being received by a fish.

2. Description of the Related Art

A fisherman encounters several problems while fishing. Many of the problems relate to the use of bare hooks, in combination with lures or not, that are exposed to objects within the water. By way of example, fish hooks get snagged in weeds and get caught on rocks, logs, debris and the like. The potential for this is great with every cast of the hook into the water. If the line isn't broken as a result of the snag, the hook is dulled from the encounter.

There have been many attempts at protecting the hooks while maximizing the efficiency of the fishing experience. U.S. Pat. No. 4,726,142 discloses a spring-loaded fish hook assembly. This assembly has two legs terminating in a pair of barbed hooks. A loop is formed in the middle of the legs and provides a means for securing the fish hook assembly to a fishing line. A trigger arm has a latch which cooperates with a catch member to have the hooks overlap each other. When the trigger arm is released, the hooks are released to catch the fish that has triggered the fish hook assembly. While the concept of having releasable hooks provides an advantage to the fisherman, the hooks are still somewhat exposed to the obstacles found within the water and the opportunity for snagging weeds is far from remote due to the exposed barbs.

### SUMMARY OF THE INVENTION

A fishing lure assembly, which is securable to a fishing line, includes a housing that defines an interior space. The fishing lure assembly includes a fulcrum secured to the housing. A hook is fixedly secured and extends out from the fulcrum oriented in an extended position such that a portion of the hook extends outside the housing. The fishing lure assembly also includes a trigger that is rotatably secured within the housing for receiving and holding the hook in a retracted position such that the hook will move to the extended position upon being released by the trigger as the trigger rotates.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention within artificial bait, shown in phantom;

FIG. 2 is a cross-sectional side view of one embodiment of the invention with the hooks in retracted positions;

FIG. 3 is a cross-sectional side view of the invention with the hooks in the extended positions; and

FIG. 4 is a cross-sectional end view of the invention.

### DETAILED DESCRIPTION OF THE PREFERRED EMBODIMENT

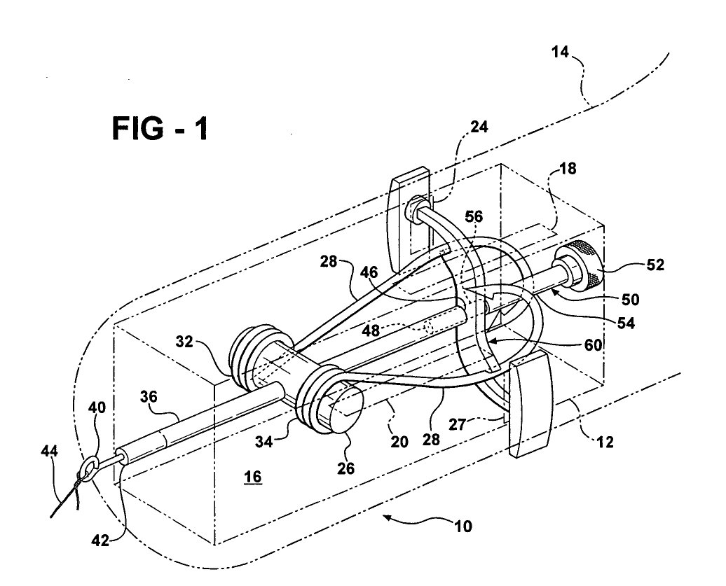

Referring to FIGS. 1 through 4, a fishing lure assembly is generally indicated at 10. The fishing lure assembly 10 includes a carriage or housing 12 that is embedded or encased within artificial bait 14. The artificial bait 14 may be hard or soft bait and it is contemplated that the artificial bait 14 would be manufactured such that it would provide a space for the insertion of the fishing lure assembly 10 therein. It should be appreciated by those skilled in the art that the fishing lure assembly 10 could be manufactured separate from the artificial bait 14, thus allowing the fishing lure assembly 10 to be inserted into any artificial bait 14 with which a fisherman would want to match the fishing lure assembly 10. For purposes of simplicity, the remainder of the discussion of the fishing lure assembly 10 will be associated with an artificial bait 14 that is soft in nature.

The housing 12 defines an interior space 16. The housing 12 also includes slots 18, 20 and openings 22, 24. The slots 18, 20 and the openings 22, 24 will be discussed in greater detail subsequently.

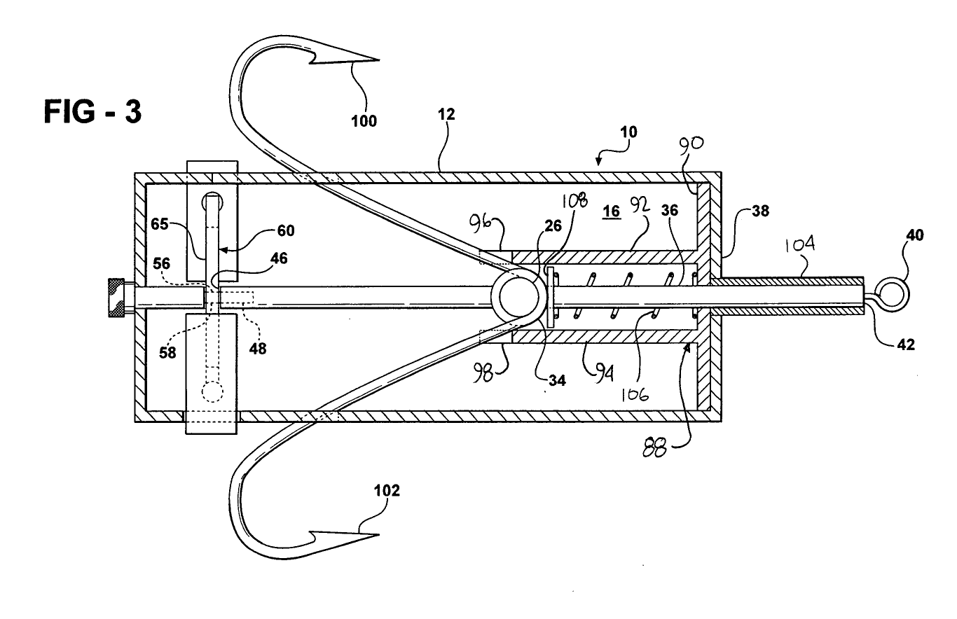

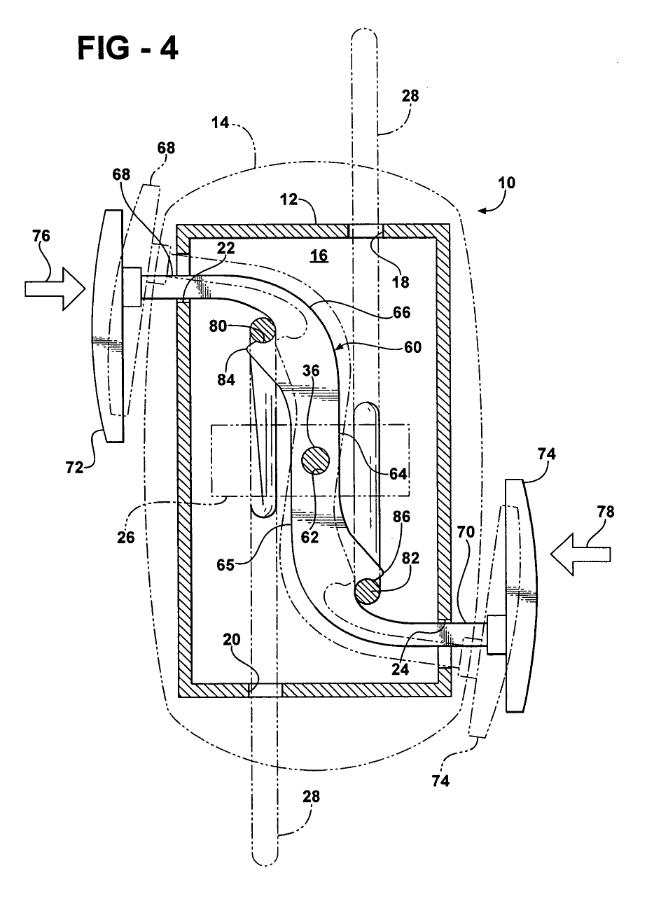

The fishing lure assembly 10 includes a fulcrum 26 that extends therethrough. The fulcrum 26 has a hook 28 wrapped thereabout. In the embodiment shown in the Figures, there are two hooks 28 that are wrapped about or around the fulcrum 26. In one embodiment, the hooks 28 are fabricated from a single strand of metal. The hooks 28 are wound such that, in their relaxed state, they extend outside of the housing 12, shown in FIG. 3 and in phantom in FIG. 4. Wrap portions 32, 34 of the hooks 28 create a spring force that is minimized when the hooks 28 are in the extended position.

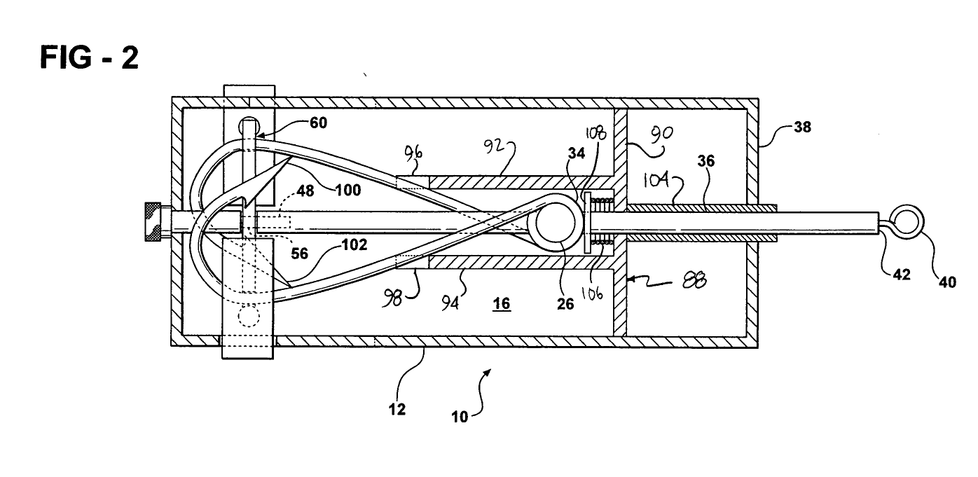

In the preferred embodiment, shown in FIG. 1, the slots 18, 20 are configured to facilitate manipulation by a person that is right handed. In an alternative embodiment shown in FIGS. 2 through 4, the slots 18, 20 are positioned opposite that of the positions shown in FIG. 1 to facilitate manipulation by a person that is left handed. It should be appreciated by those skilled in the art that the position of the slots 18, 20 can be either of these two positions without changing the inventive entity. Regardless of the position of the slots 18, 20, the slots 18,20 must always be extending up and down so the bumpers (discussed subsequently) can be positioned laterally with respect to the housing 12. This maximizes the ability of the fishing lure assembly 10 be retained in the mouth of a fish. In other words, the hooks 28 extending up and down will have a better chance of being embedded into the fish than if the hooks 28 were to extend out laterally from the housing 12.

Extending through a portion of the housing 12 is a barrel 36. In the embodiment shown, the barrel 36 extends through the fulcrum 26. The barrel 36 extends out of the housing 12 through an anterior end 38 thereof. An eyelet 40 is secured to the barrel 36 at an anterior, exposed end 42. The eyelet 40 is used to facilitate the attachment of the fishing lure assembly 10 to a fish line 44. The barrel 36 extends from the exposed end 42 to a distal end 46 within the inner space 16. The distal end 46 includes a threaded interior 48 that receives a barrel button, generally shown at 50. The barrel button threadingly engages the threaded interior 48 of the distal end 46.

The barrel button 50 has a button 52 designed for manual rotation. The button 52 is inside the housing 12 and is only accessed when the housing 12 is taken apart. The housing 12 may be taken apart should any parts within the housing 12 need to be replaced or refurbished.

The button barrel 50 includes a button shaft 54. The button shaft includes a male threaded portion 56 which is smaller in diameter than the button shaft 54. The male threaded portion 56 threadingly engages the threaded interior 48 of the distal end. Together, the barrel 36, the button shaft 54 and the male threaded portion 56 define a relief 58. The relief 58 is an effective reduction of diameter in the barrel 36.

The fishing lure 10 assembly also includes a trigger, generally indicated at 60. The trigger 60 is rotatably secured within the housing 12. The trigger 60 receives and holds the hooks 28 in their respective retracted positions such that the hooks 28 will move to their respective extended positions upon being released by the trigger 60 as it rotates. The trigger 60 defines a hole 62 at a rotation end 64 of the trigger 60. While the rotation end 64 is shown to be in a middle section 65 of the trigger 60, it is contemplated that the rotation end 64 may be an end about which the trigger 60 rotates in alternative embodiments should a single hook or an odd number of hooks be used. The hole 62 receives the male threaded portion 56 of the button shaft 54 therethrough. The relief 58 positions the trigger 60 within the housing 12 preventing the trigger 60 from moving with respect to the housing 12 other than rotating about the male threaded portion 56.

The trigger 60 includes a bellcrank 66 that rotates about the rotation end 64. The bellcrank 66 includes the middle section 65 and extends between the rotation end 64 and a bumper end 68. Because the embodiment of the fishing lure assembly 10 is shown having two hooks 28, the bellcrank 66 has two bumper ends 68, 70, which complement each other about the rotation end 64 and hole 62. Each of the bumper ends 68, 70 include a bumper 72, 74, which is snap fit onto the bumper ends 68, 70. The bumpers 72, 74 are snap fit into place so they can be removed should the housing 12 require disassembly for repair or replacement of the hooks 28. The bumper end 68, 70 and the bumpers 72, 74 extend outside the housing 12 allowing the bumpers 72, 74 to receive forces generated by a fish closing its mouth over the fishing lure assembly 10 forcing the bumpers 72, 74 inwardly with respect to the housing 12 as is shown in phantom in FIG. 4. The forces, generally represented by arrows 76, 78 may be directed at any angle generally inwardly toward the interior space 16 of the housing 12.

The trigger 60 also includes nesting surfaces 80, 82 which extend between the bellcrank 68 and trigger branches 84, 86 respectively. The nesting surfaces 80, 82 are curved and hold the hooks 28 in their retracted positions.

In operation, the lure tool 88 is used to retract the hooks 28 such that they are received by the nesting surfaces 80, 82 of the trigger 60. This defines the retracted positions for each of the hooks 28 The fishing lure assembly 10 is then cast into an area to fish. When a fish receives the fishing lure assembly 10 in its mouth, forces 76, 78 generated by the fish mouthing the fishing lure assembly 10 will force the bumpers 72, 74 to rotate the bellcrank 66. Rotation of the bellcrank 66 releases the hooks 28 by forcing the nesting surfaces 80, 82 to move laterally away from the hooks 28 such that the hooks 28 spring to their extended positions exposing their pointed ends 100, 102 (the pointed ends 100, 102 may be barbed or non-barbed) to catch the fish.

Once the hooks are released, they must be reset. To do so, the hooks 28 must be forced back into engagement with the nesting surfaces 80, 82 of the trigger 60. A cocking device 88 is incorporated into the fishing lure assembly 10 to cock the hooks 28 back into engagement with the trigger 60 to reuse the fishing lure assembly 10. The cocking device 88 includes an alignment plate 90 which extends through the entire cross section of the interior space 16 of the housing 12. The alignment plate 90 includes two hook engaging arms 92, 94 that extend out perpendicularly therefrom. The hook engaging arms 92, 94 have forked distal ends 96, 98 to guide the hooks 28 when they are being forced back into the housing 12.

A cylinder 104 extends out from the alignment plate 90 perpendicularly therefrom in a direction opposite of the direction of the hook engaging arms 92, 94. The cylinder 104 extends over a portion of the barrel 36 and out past the artificial bait 14. The fisherman forces the cylinder 104 into the housing 12 which will, in turn, force the hook engaging arms 92, 94 into the hooks 28 to force the hooks 28 back down into the housing 12 and into engagement with the trigger 60.

The cocking device 88 also includes retraction spring 106. The retraction spring 106 retracts the cocking device 88 to a position away from the hooks 28 to allow the hooks 28 to move freely outside the housing 12 when the trigger 60 releases them. Therefore, unless a force is being applied to the cylinder 104 by the fisherman using the fishing lure assembly 10, the retraction spring 106 maintains the cocking device 88 in a retracted position, thus allowing the full range of motion designed for the hooks 28. The cocking device 88 also includes a spring plate 108 that abuts the wrapped portions 32, 34 of the hooks 30 to assist in maintaining the retraction spring 106 in the proper position by creating a surface against which the retraction spring 106 may abut without creating alternative forces in directions other than parallel to the barrel 36.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A fishing lure assembly securable to a fishing line, said fishing lure assembly comprising;
a housing defining an interior space;
a fulcrum secured within said housing;
a hook fixedly secured to and extending out from said fulcrum oriented in an extended position such that a portion of said hook extends outside said housing; and
a trigger rotatably secured within said housing for receiving and holding said hook in a retracted position such that said hook will move to said extended position upon being released by said trigger as it rotates.

2. A fishing lure assembly as set forth in claim 1 including a cocking device for re-engaging said hook with said trigger after said hook is released by said trigger.

3. A fishing lure assembly as set forth in claim 2 including a barrel extending through said interior space to position said trigger with respect to said hook.

4. A fishing lure assembly as set forth in claim 3 wherein said housing defines a slot allowing said hook to pass therethrough when said hook moves between said retracted and extended positions.

5. A fishing lure assembly as set forth in claim 4 wherein said housing further includes a hole providing access for said trigger to extend outside said housing.

6. A fishing lure assembly as set forth in claim 5 wherein said trigger is a bellcrank extending between a rotation end and a bumper end.

7. A fishing lure assembly as set forth in claim 6 wherein said bumper end extends outside said housing.

8. A fishing lure assembly as set forth in claim 7 including a bumper pad fixedly secured to said bumper end of said trigger to receive forces produced by a fish that has swallowed said fishing lure assembly.

9. A fishing lure assembly as set forth in claim 8 wherein said barrel includes a relief portion.

10. A fishing lure assembly as set forth in claim 9 wherein said trigger includes a hole disposed adjacent said rotation end.

11. A fishing lure assembly as set forth in claim 10 wherein said trigger is movably secured to said barrel by said hole receiving said relief portion therein.

12. A fishing lure assembly as set forth in claim 11 including a barrel button threadingly securable to said relief portion of said barrel to axially retain said trigger about said relief portion.

13. A fishing lure assembly securable to a fishing line, said fishing lure assembly comprising;
a housing defining an interior space;
a fulcrum secured within said housing;
a hook fixedly secured to and extending out from said fulcrum oriented in an extended position such that a portion of said hook extends outside said housing;
a trigger rotatably secured within said housing for receiving and holding said hook in a retracted position such that said hook will move to said extended position upon being released by said trigger as it rotates; and
a barrel defining a relief portion, and extending through said interior space to position said trigger with respect to said hook.

14. A fishing lure assembly as set forth in claim 13 wherein said housing defines a slot allowing said hook to pass therethrough when said hook moves between said retracted and extended positions.

15. A fishing lure assembly as set forth in claim 14 wherein said housing further includes a hole providing access for said trigger to extend outside said housing.

16. A fishing lure assembly as set forth in claim 15 wherein said trigger is a bellcrank extending between a rotation end and a bumper end.

17. A fishing lure assembly as set forth in claim 16 wherein said bumper end extends outside said housing.

18. A fishing lure assembly as set forth in claim 17 wherein said trigger includes a hole disposed adjacent said rotation end.

19. A fishing lure assembly as set forth in claim 18 wherein said trigger is movably secured to said barrel by said hole receiving said relief portion therein.

20. A fishing lure assembly as set forth in claim 19 including a barrel button threadingly securable to said relief portion of said barrel to axially retain said trigger about said relief portion.

21. A fishing lure assembly securable to a fishing line, said fishing lure assembly comprising;
a housing defining an interior space;
a fulcrum secured within said housing;
a plurality of hooks fixedly secured to and extending out from said fulcrum oriented in an extended position such that a portion of each of said plurality of hooks extends outside said housing; and
a trigger rotatably secured within said housing for receiving and holding said plurality of hooks in a retracted position such that said plurality of hooks will move to said extended position upon being released by said trigger as it rotates, said trigger including a plurality of nesting surfaces for receiving and holding each of said plurality of hooks in the retracted positions.

22. A fishing lure assembly as set forth in claim 21 including a cocking device for re-engaging said hook with said trigger after said hook is released by said trigger.

23. A fishing lure assembly as set forth in claim 22 wherein said cocking device includes an alignment plate extending through a cross section of said interior space of said housing.

24. A fishing lure assembly as set forth in claim 23 wherein said alignment plate includes a plurality of hook engaging arms extending outwardly therefrom perpendicularly to said alignment plate, each for engaging each of said plurality of hooks.

25. A fishing lure assembly as set forth in claim 24 wherein each of said plurality of hook engaging arms includes a hooked distal end for guiding each of said plurality of hooks back to engagement with said trigger.

26. A fishing lure assembly as set forth in claim 25 including a cylinder fixedly secured to said alignment plate and extending out of said housing to move said alignment plate with respect to said housing.
